(19) United States
(12) Patent Application Publication
(10) Pub. No.: US 2016/0332668 A1
(43) Pub. Date: Nov. 17, 2016

(54) Stiffening Structure of a Vehicle in the Form of a Shear Field

(71) Applicant: Bayerische Motoren Werke Aktiengesellschaft, Muenchen (DE)

(72) Inventors: Andreas PIENKOHS, Lichtenow (DE); Robert LOEFFLER, Moosburg (DE)

(21) Appl. No.: 15/219,451

(22) Filed: Jul. 26, 2016

Related U.S. Application Data
(63) Continuation of application No. PCT/EP2015/053550, filed on Feb. 19, 2015.

(30) Foreign Application Priority Data
Mar. 5, 2014 (DE) 10 2014 204 052.3

(51) Int. Cl. B62D 21/11; B62D 35/02; B62D 25/20

(52) U.S. Cl. CPC B62D 21/11; B62D 25/2036; B62D 25/2072; B62D 35/02

(57) ABSTRACT

A stiffening structure of a two-track vehicle is provided in the form of a shear field designed as a shaped sheet-metal piece. The shear field is fastened to a sub-frame acting as an axle support and optionally to longitudinal members of the vehicle and furthermore is supported on lateral door sills of the vehicle body. The support is provided by supporting arms formed in the shaped sheet metal piece. The supporting arms or further segments of the shear field can be stiffened by auxiliary sheets in such a way that there is a shell profile formed by a top shell and a bottom shell as viewed in the direction of the vehicle vertical axis.

### CROSS REFERENCE TO RELATED APPLICATIONS

This application is a continuation of PCT International Application No. PCT/EP2015/053550, filed Feb. 19, 2015, which claims priority under 35 U.S.C. §119 from German Patent Application No. 10 2014 204 052.3, filed Mar. 5, 2014, the entire disclosures of which are herein expressly incorporated by reference.

### BACKGROUND AND SUMMARY OF THE INVENTION

The invention relates to a stiffening structure of a two-track vehicle, in the form of a shear field which is designed as a shaped sheet-metal piece. The shaped sheet-metal piece is supported on a subframe, which acts as an axle support, and furthermore on lateral sills of the vehicle body. The sills, which are also referred to as door sills, are, as is known, elements of a self-supporting motor vehicle bodywork, i.e. of the vehicle body. The door sills extend laterally, i.e. as viewed in the transverse direction of the vehicle, on both sides in the longitudinal direction of the vehicle outside customary longitudinal members. For the prior art, reference is made to EP 0 941 912 B1, to DE 10 2012 010 552 A1.

Flat stiffening elements in the region of vehicle subframes are known in a wide variety of embodiments and are recently being increasingly used as “shear fields” because of ever more extensive lightweight construction structural measures. EP 0 941 912 B1 shows a relatively early embodiment, while DE 10 2012 010 552 A1 shows a possible development in which the shear field is additionally supported on the lateral sills of the vehicle body, when the vehicle analogously to the present invention is primarily a passenger vehicle, via “diagonal struts” there.

It is an object of the invention to provide a further improved shear field.

This and other objects are achieved in that the shear field is supported on the sills via supporting arms formed in the shaped sheet-metal piece. Advantageous designs and developments are also described and claimed herein.

According to the invention, “supporting arms” are, for their part, part of the shaped sheet-metal piece forming the shear field, via which that region or portion of the shear field, which lies substantially between supports of the subframe that extend substantially in the longitudinal direction of the vehicle and transverse direction of the vehicle, is furthermore supported on the lateral sills of the vehicle body via the supporting arms. By this means, the installation and manufacturing outlay can be reduced, in particular by the shear field being designed as a shaped sheet-metal part which is produced by punching and non-cutting forming as a single shaped part which is cohesive per se.

Within the context of advantageous developments, at least one auxiliary sheet can be provided for stiffening the shear field in such a manner that a shell profile formed by an upper shell and a lower shell is virtually present in portions or in regions, as viewed in the direction of the vertical axis of the vehicle. Such an additional stiffening is recommended in particular for the supporting arms, but may also be provided in the region of a receptacle, which is provided on the axle support, for an engine bearing or on other portions of the shear field, for example in particular at an attachment point for a further component. Therefore, an auxiliary sheet is thus attached on one or more defined portions of the shear field or of a large sheet-metal part which forms the latter and extends over the entire surface region of the shear field. The auxiliary sheet is welded in its edge region to the respective portion or to the large sheet-metal part which has just been mentioned and which forms the entire surface region of the shear field. More or less within the welded joint encircling the auxiliary sheet, the auxiliary sheet can be slightly spaced apart from the large sheet-metal part, apart from optionally provided supporting beads or the like.

By means of the provision of an auxiliary sheet, a partially multi-shell construction proposed here can be provided preferably at attachment points (for example to the sill, but also to an engine bearing or to further screw connection points, for example also of the shear field itself). In this way, an increased rigidity in comparison to a shear field consisting only of a single sheet-metal part or of a connection of a plurality of separate profiles can be achieved. Such a multi- or dual-shell structure is preferably provided only wherever increased demands are imposed on the rigidity of the shear field. This results in a weight optimization in comparison to a shear field having a stiff design over the full surface area. Equivalent rigidity could namely be achieved on a single-shell sheet only by increasing the wall thickness, which would be associated with a massive increase in weight. Furthermore, the proposed multi-shell structure results in increased use of construction space since the limited deformability of a single-shell solution or use of a plurality of additional profiles in the case of a “strut solution” is not adhered to.

The shear field or a stiffening structure of a two-track vehicle can extend into the frontmost region of the axle support or subframe mentioned, as viewed in the direction of travel, and can therefore take over the function of covering a steering mechanism in the region of the front axle of the vehicle. Therefore, a further, corresponding, separate installation part is not required. This reduces the outlay on installation and the number of parts. At the same time, this provides protection against damage to the steering mechanism in the event of “beaching” the vehicle. Furthermore, with such a structure, which is virtually continuous over a wide region, an improved aerodynamic behavior of the vehicle can also be achieved.

For the additional stiffening of the front end of the vehicle, the shear field can furthermore be supported or fastened to the longitudinal member directly, or indirectly via a (further) intermediate element (in addition to the axle support). Furthermore, a shear field according to the invention can be configured in a particularly simple manner for the purpose of at least proportionally bearing the weight of a relatively large electric coil, via which an electric battery provided in the vehicle can be inductively charged. Accordingly, a stiffening structure according to the invention can have a receptacle for such an electric coil.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a view from above (directed perpendicularly toward the carriageway) of a front axle support (subframe) of a two-track vehicle with a shear field (stiffening structure) arranged therebelow;

FIG. 2a illustrates the shear field or stiffening structure by itself, i.e. in the same view without the axle support;

FIG. 2b illustrates the shear field or stiffening structure in a view from below, i.e. directed upward from the carriageway; and

FIG. 3 likewise shows the shear field in a view from below, including the axle support, in the state mounted on the vehicle, and therefore also part of the vehicle underbody; the orientation of the shear field with respect to the vehicle follows here from the arrow F depicting the direction of travel of the vehicle.

### DETAILED DESCRIPTION OF THE DRAWINGS

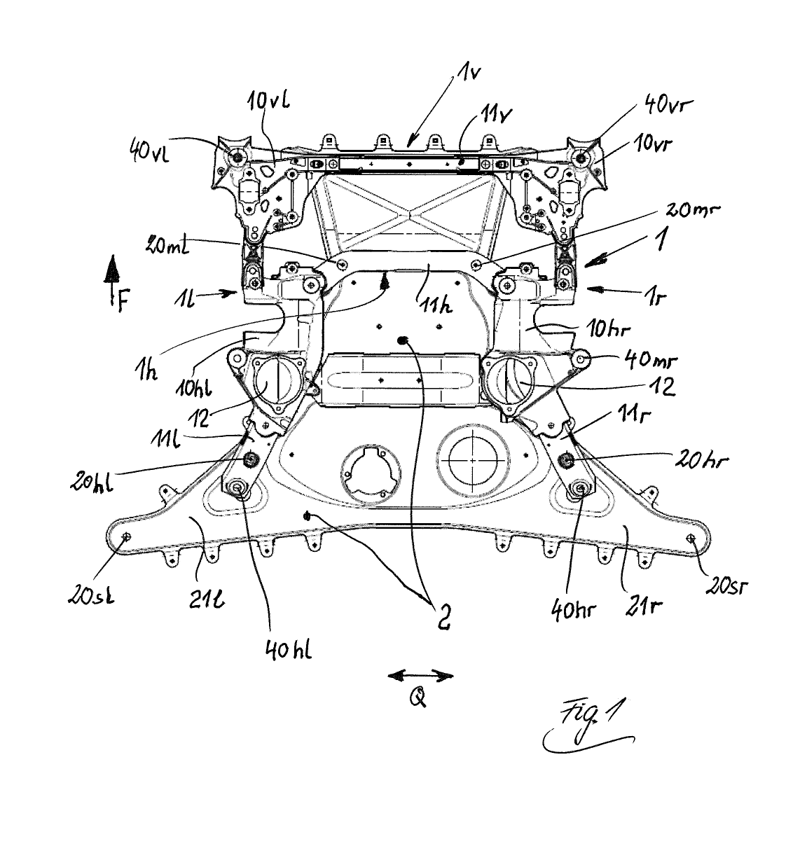

First of all, in particular with reference to FIG. 1, a subframe acting as an axle support in the region of the front axle of a passenger vehicle is identified in its entirety by the reference sign 1. The subframe 1 substantially consists (as viewed in the direction of travel F) of a front functional frame crossmember 1v, a rear functional frame crossmember 1h and a left and a right functional frame longitudinal member 1l, 1r, wherein the term “functional member” is intended to clarify that this does not in each case involve an actual single component, but that actual components or structures are present which, in interaction with one another, form said functional members. In the two front corner regions of the auxiliary frame 1, there are therefore corner structures 10vl (“front left”), 10vr (“front right”) which are formed as cast nodes, and which also extend for a certain extent in the direction of the individual functional members and which are connected to one another via a front strut structure 11v. Two rear cast nodes 10hl (“rear left”), 10hr (“rear right”) firstly receive a rear strut structure 11h and furthermore a right or left strut structure 11r or 11l, as illustrated in FIG. 1. The rear frame crossmember 1h is therefore of approximately V-shaped design, as can be seen, while the front frame crossmember 1v is of substantially linear design. The two lateral frame longitudinal members 1l, 1r are substantially formed by a connection of the corner structures 10vr and 10hr or 10vl and 10hl to the respective strut structure 11r or 11l. Furthermore, a receptacle 12 for an engine bearing, on which the drive unit of the vehicle is mounted, is provided in each rear corner structure 10hl or 10hr, but the detailed configuration of the axle support 1 merely plays a subordinate role for the present invention.

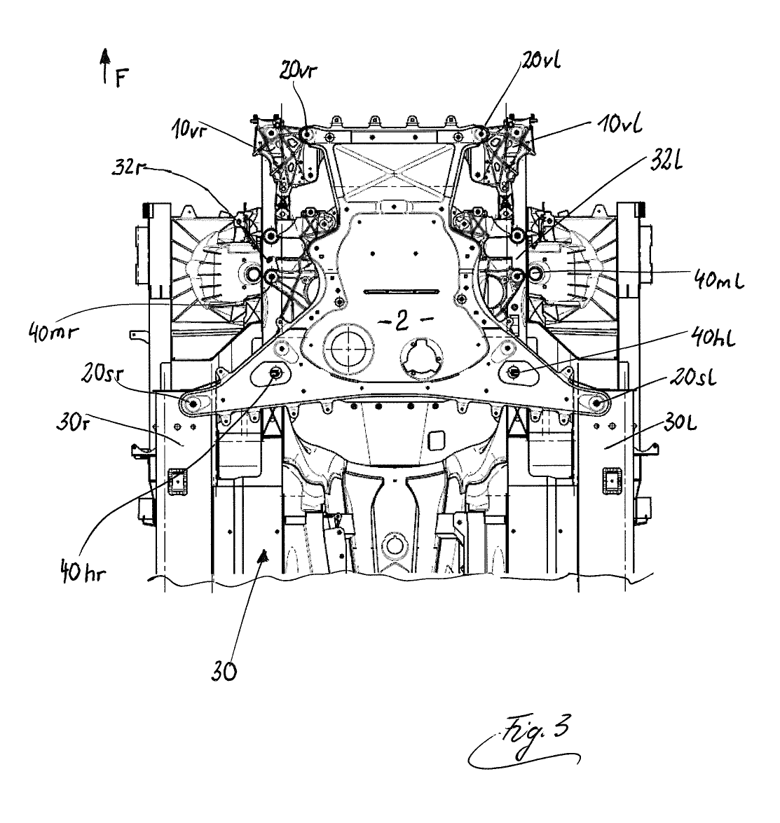

In the state fitted on the vehicle, the subframe or axle support 1 is stiffened by a shear field 2, which is designed as a substantially flat shaped sheet-metal piece (made of suitable steel sheet) and which, in the present exemplary embodiment, is fastened to the subframe 1 from below at six points via screw connections. Two front fastening points 20vl, 20vr are provided on the front corner structures 10vl, 10vr (only visible in FIG. 3), while, passing rearward counter to the direction of travel F. According to FIG. 1, central fastening points 20ml and 20mr are respectively provided on the left side and right side on the rear strut structure 11h and, even further to the rear in comparison thereto, rear fastening points 20hl and 20hr are provided on the left and right strut structure 11l and 11r of the rear functional frame crossmember 1h.

As is apparent, the shear field 2 also extends rearward for a certain extent over the two rear fastening points 20hl and 20hr, as viewed counter to the direction of travel F, and in particular outward in the transverse direction of the vehicle Q in relation to the fastening points. Therefore, respective supporting arms 21l and 21r are formed, as it were, emerging substantially laterally outward from the rear fastening points 20hl and 20hr in the shear field 2. The supporting arms extend as far as the respective lateral sills 31l and 31r of the underbody 30 (shown in FIG. 3) of the vehicle body. The shear field 2 is fastened on the left side and on the right side of the vehicle to the sills 30l, 30r in each case at a further fastening point 20sl, 20sr via screw connections.

FIG. 3 furthermore shows a longitudinal member 32l or 32r running substantially in the direction of travel F on the left side and right side of the vehicle center on or in the underbody 30, which longitudinal members 32l, 32r may also be referred to as bodywork longitudinal members or as engine longitudinal members. The strut structures 11l and 11r of the axle support 1 are releasably fastened by the free end portions thereof to the respective longitudinal member 32l, 32r at respective fastening points 40hl and 40hr (cf. also FIG. 1), and, furthermore, each corner structure 10hl, 10hr, 10vl, 10vr is releasably connected to one of the members 32l or 32r at fastening points 40ml, 40mr, 40vl, 40vr via screw connections. The axle support or subframe 1 is therefore fastened to the vehicle, more precisely to the longitudinal members 32l, 32r thereof, via the fastening points mentioned.

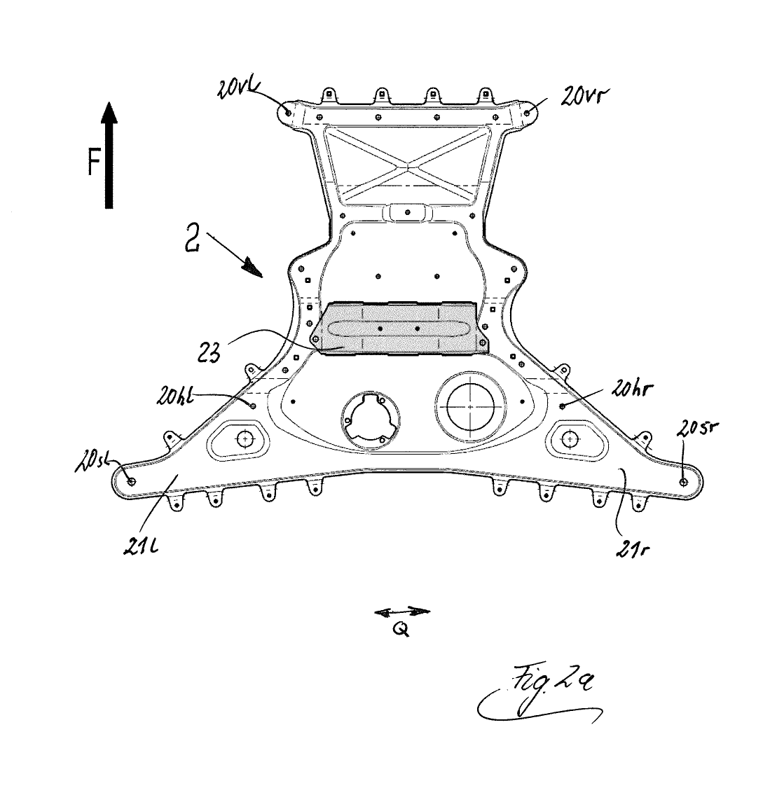

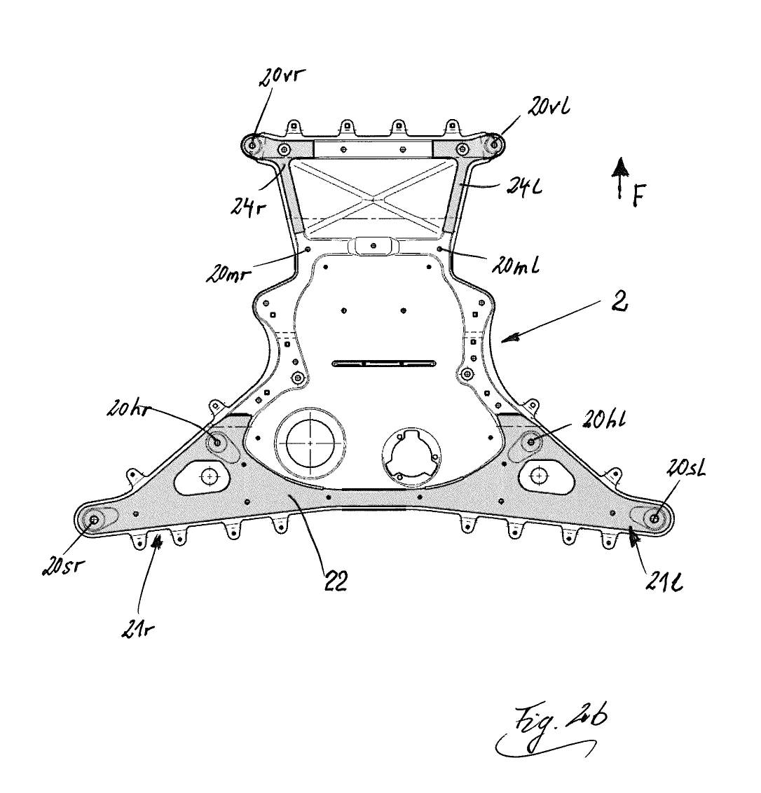

The dual-shell or multi-shell structure of individual portions of the shear field 2, mentioned above, which individual portions of the shear field 2 consist as it were of an upper shell and a lower shell by auxiliary sheets being attached in sections to the sheet-metal part extending over the entire surface region of the shear field 2, is best revealed in FIGS. 2a, 2b. These figures are explained below, wherein the auxiliary sheets attached to the large sheet-metal part (illustrated uncolored) are illustrated in darker form, i.e. in gray.

According thereto, the shear field 2 is stiffened in regions or sections by auxiliary sheets 22, 23, 24l, 24r which are placed onto the shear field 2 or onto the sheet-metal part thereof extending over the entire surface region of the shear field 2, preferably with the formation of an intermediate space, and are fixedly connected, in particular in an integrally bonded manner, on the edge side to the shear field. A shell profile formed by an upper shell and a lower shell is therefore virtually represented in the respective region or portion, as viewed in the direction of the vertical axis of the vehicle. In the present case, such a stiffening of the shear field 2 is provided in the region of each supporting arm 21l, 21r, wherein a cohesive auxiliary sheet 22 which, extending from the left supporting arm 21l to the right supporting arm 21r, is applied here in the previously described manner to the lower side of the large sheet-metal part extending over the entire surface region of the shear field 2, as revealed in FIG. 2b.

The shear field 2 between the receptacles 12 for engine bearings, which receptacles have already been mentioned and are provided on the axle support 1, is stiffened in a comparable manner by way of an auxiliary sheet 23 which extends in the transverse direction Q of the vehicle and is applied in the previously described manner to the upper side of the large sheet-metal part extending over the entire surface region of the shear field 2, as revealed in FIG. 2a. Furthermore, in an analogous manner, auxiliary sheets 24l, 24r in the front edge regions of the shear field 2 in the environment of the corner structures 10vl, 10vr of the axle support 1 are now in turn applied in the previously described manner to the lower side of the large sheet-metal part extending over the entire surface region of the shear field 2, as FIG. 2b shows.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A stiffening structure of a two-track vehicle having a subframe acting as a axle support and having lateral sills of a vehicle body, the stiffening structure comprising:
a shear field configured as a shaped sheet-metal component supportable on the subframe and on the lateral sills of the vehicle body, wherein
the shear field has supporting arms formed in the shaped sheet-metal piece via which the shear field is supported on the lateral sills.

2. The stiffening structure according to claim 1, further comprising:
an auxiliary sheet configured to stiffen the supporting arms of the shear field, wherein
the auxiliary sheet extends substantially parallel to the supporting arms and forms a shell profile with the supporting arms having an upper shell and a lower shell viewed in a vertical axis direction of the vehicle.

3. The stiffening structure according to claim 2, wherein the auxiliary sheet additionally stiffens another portion of the shear field.

4. The stiffening structure according to claim 2, further comprising:
another auxiliary sheet configured to stiffen the shear field in a region between receptacles provided on the axle support for engine bearings, wherein the additional auxiliary sheet forms a shell profile with the shear field having an upper shell and a lower shell viewed in the vertical axis direction of the vehicle.

5. The stiffening structure according to claim 1, wherein the shear field is configured to be fastenable directly or indirectly to longitudinal members of the vehicle.

6. The stiffening structure according to claim 1, wherein the shear field comprises a receptacle for an electric coil.
